(19) United States
(12) Patent Application Publication
(10) Pub. No.: US 2012/0316949 A1
(43) Pub. Date: Dec. 13, 2012

(54) METHOD AND SYSTEM FOR MANAGING ELECTRONIC COUPONS

(76) Inventor: Bilin Chen, Cupertino, CA (US)

(21) Appl. No.: 13/060,277

(22) PCT Filed: Dec. 14, 2010
(86) PCT No.: PCT/CN10/79775

§ 371 Date: Feb. 23, 2011

(30) Foreign Application Priority Data
Feb. 5, 2010 (CN) 201019114073.2

(51) Int. Cl. G06Q 30/02

(52) U.S. Cl. 705/14.26

(57) ABSTRACT

A method and a system for managing electronic coupons utilize a merchant identifier and a consumer characteristic, and package such information into a verification request for redemption of the electronic coupon as a form of receipt or proof of redemption. The server sends an electronic coupon to the consumer's mobile electronic device upon request. During a purchase, the consumer presents the electronic coupon to the merchant, and receives a merchant identifier. The merchant identifier and a consumer characteristic are included into a verification request for redemption of the electronic coupon and sent to the server. The server verifies the verification request according to the information contained therein to allow the redemption of the coupon, and stores the verification information for future coupon processing.

### RELATED APPLICATIONS

This application claims priority from Chinese patent application, Application No. 201019114073.2, filed Feb. 5, 2010, entitled “METHOD AND SYSTEM FOR MANAGING ELECTRONIC COUPONS”.

### BACKGROUND

The present disclosure relates to the field of managing electronic coupons, and particularly relates to methods and systems of managing electronic coupons which are used on mobile electronic devices.

In commercial transactions that involve coupons, there are potentially four important parties: coupon issuers, redemption merchants, facilitators, and consumers. A coupon issuer is typically a manufacturer or service provider. A redemption merchant is typically a retailer or a service provider. A coupon facilitator may be an advertising agent responsible for coupon dissemination, or a company playing one or more of such roles including coupon auditing, coupon settlement, and coupon analysis. A consumer is usually a buyer of a product or service. In some cases, the issuer and the redemption merchant may be the same company. For example, a restaurant may issue coupons to attract customers to its own business. In this case, the restaurant is both the coupon issuer and the redemption merchant. In some cases, there may be no separate facilitator outside of the issuer and the redemption merchant. The above parties constitute an ecosystem in which the information flow and the cooperation relationships among the parties determine the quality of the couponing process.

In the past, much attention has been given to the means to disseminate the coupons. One focus has been on the convenience of the consumer in accessing, retrieving, storing, and using coupons to obtain a discount on goods or services. For this reason, mobile coupons have become increasingly popular to replace or supplement the traditional coupons in print. Mobile coupons issued by a manufacturer or service provider are distributed in an electronic form and appear on a mobile electronic device such as a mobile phone of the consumer. The consumer then presents the coupon to the merchant visually or by optical scanning in order to redeem the coupon.

The mobile coupons, however, have their own issues. It is difficult to control the number of mobile coupons issued; a single coupon may be used more times than it is intended to be used; it is also possible that a mobile coupon is downloaded and applied at the checkout of the merchant after the consumer has already decided to buy the product regardless of the coupon, very much negating the advertising and promotional effect of the coupon.

However, the ease of coupon dissemination, the convenience of the consumers, and even the validity of the coupon, are just some of the numerous factors that affect the quality of couponing process. In a complete coupon system, what is even more important is often record-keeping of transactions such as proof of redemption and receipts associated with coupons, and evidences in cooperation relationships among coupon issuers, redemption merchants, coupon facilitators and consumers. For example, in the use of printed coupons, counterfeit copies have posed a problem. Frauds in coupon clearing and settlement corrupt the coupon ecosystem. In the use of electronic mobile coupons, one prominent problem is the lack of proof of redemption that can be trusted by the coupon issuers and even merchants themselves.

There is therefore a need for a coupon system that improves coupon record-keeping and cooperation relations in the couponing process.

### SUMMARY OF THE DISCLOSURE

Disclosed are a method and a system for managing electronic coupons. The method and the system utilize a merchant identifier and a consumer characteristic, and package such information into a verification request for redemption of an electronic coupon. The information request containing such information is retained as a form of receipt or proof of redemption.

In one embodiment of the method, a server sends an electronic coupon to a consumer's mobile electronic device upon request. During a purchase by the consumer at a merchant, the consumer presents the electronic coupon to the merchant, and receives a merchant identifier into the mobile electronic device. The server receives from the mobile electronic device the verification request for redemption of the electronic coupon containing the merchant identifier and characteristic of the consumer. The server verifies the validity of the coupon and sends a verification result to the mobile electronic device to allow the redemption of the coupon by the merchant. The server further stores the information of the verification request for redemption for future coupon processing.

The merchant identifier preferably allows the coupon server system to uniquely identify the merchant. The consumer characteristic may be a mobile phone number, a hardware identification number or an e-mail address.

The server in one embodiment contains a coupon account system to receive, issue and audit coupons. Both coupon issuers and redemption merchants may have an account established in the coupon account system. The coupon issuer and the redemption merchant may or may not be the same entity. The server allows the coupon issuer and the redemption merchant to access through their respective account the data derived from the verification request for redemption.

Another aspect of the present disclosure is a downloadable software application package which can be stored on one or more computer readable media. The software application package includes a plurality of instructions that, when installed on a mobile electronic device and executed by a processor through user interaction, causes the mobile electronic device to perform the coupon redemption procedure through interactive user operations, as described herein.

The method and the system facilitate record-keeping of couponing process to improve coupon auditing, settlement and analysis. The method and the system may further improve the cooperation relationship between the redemption merchant and the coupon issuer during coupon clearing if they are separate entities.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF DRAWINGS

The detailed description is described with reference to the accompanying figures. In the figures, the left-most digit(s) of a reference number identifies the figure in which the reference number first appears.

FIG. 1 shows an exemplary environment in which the system and method of managing electronic coupons is applied.

FIG. 2 shows an exemplary block flowchart of the method for managing electronic coupons in accordance with the present disclosure.

FIG. 3 shows another exemplary block flowchart of the method for managing electronic coupons in accordance with the present disclosure.

FIG. 4 shows an integrated block flowchart illustrating the method for managing electronic coupons in accordance with the present disclosure.

FIG. 5 shows an exemplary electronic coupon interface displayed on the consumer's mobile electronic device.

### DETAILED DESCRIPTION

The method and the system for managing electronic coupons is described in further detail using exemplary embodiments accompanying figures.

In this description, the order in which a process is described is not intended to be construed as a limitation, and any number of the described process blocks may be combined in any order to implement the method, or an alternate method.

In this description, the word “coupon” carries a broad meaning to refer to any document, ticket, or certificate that can be used to exchange for a financial discount or rebate when purchasing a product or service, or for accessing an event or service. A coupon may be received by a consumer freely, as a gift, or as an incentive; a coupon may also be purchased or earned. The word “merchant” also carries a broad meaning to refer to any business, organization or individual that sells or provides a product or service to a customer. The word “consumer” broadly refers to any individual, business or organization which buys or accesses a product or service.

The present disclosure describes a method and a system for managing an electronic coupon. The method and the system package a merchant identifier and a consumer characteristic into a verification request for redemption of the electronic coupon, and retain the verification request for redemption as a form of receipt or proof of redemption. This facilitates better record-keeping of the coupon transactions for the coupon issuer and/or the redemption merchant, and also provides a useful evidentiary basis for substantiating a coupon claim when the coupon issuer and the redemption merchant are separate entities.

There are two different types of electronic coupons. The system and the method disclosed herein are applicable to both types. The first type coupons are issued by a manufacturer or a service provider for a product or a service, which is sold by another company such as a merchant or retailer. In this case, the coupon issuer and the coupon receiver are two different entities. The second type coupons are issued by a merchant for a product or service sold by the merchant itself. The product or service may be produced by the merchant itself or by another company, and the merchant nevertheless uses a coupon to promote the product or service on its own. In this case, the coupon issuer and the coupon receiver are the same entity.

The system disclosed herein is used for implementing the method of managing electronic coupons. The system may be a part of an application environment or ecosystem and be designed to perform its intended functions by communicating and interacting with other units and components thereof. The operation of the system is made possible by integrating hardware, software and electronic communications. Herein, a “unit” or “component” is a device, tool or machine designed to perform a particular task or function. A unit can be a piece of hardware, software, a plan or scheme, or a combination thereof, for effectuating a purpose associated with the particular task or function.

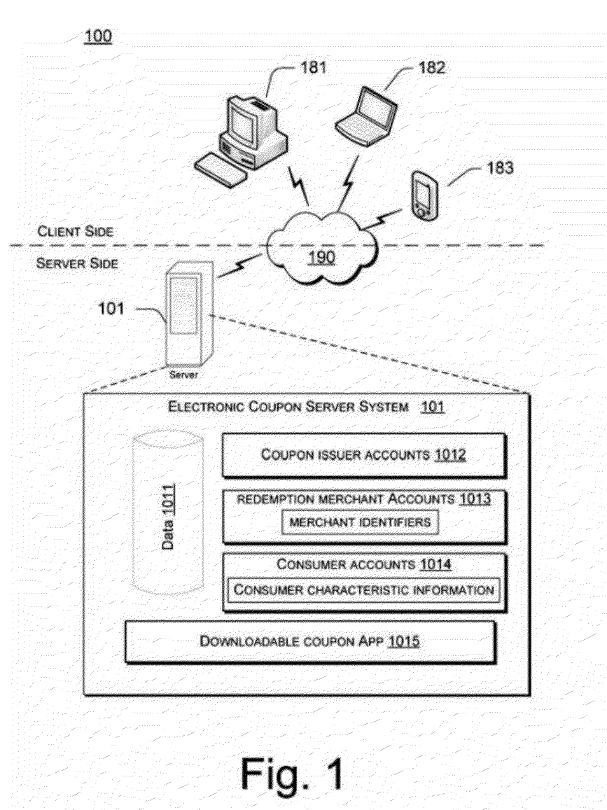

FIG. 1 shows an exemplary environment in which the system and the method of managing electronic coupons are applied. The environment 100 shows both a server side and a client side. On the server side is an electronic coupon server system 101 which may include one or more server computers or server clusters located in a single or multiple locations. The electronic coupon server system 101 has processors and data storages which are commonly used in the server computers and not shown. The electronic coupon server system 101 is programmed and configured to store necessary data 1011 including electronic coupons, user account information, product information, service information and consumer information. In one embodiment, the electronic coupon server system 101 has a user account system that contains coupon issuer accounts 1012, redemption merchant accounts 1013, and consumer accounts 1014.

A coupon issuer, such as a manufacture or a service provider, may register an account to issue coupons on the electronic coupon server system 101. A redemption merchant, such as a vendor or retailer, may also register an account for coupon verification and coupon clearing. A consumer may register a consumer account for searching, downloading and managing coupons. It is noted, however, these accounts, especially an account for the consumer, are optional. For example, a consumer may use the electronic coupon server system 101 to search and download coupons without setting up an account. However, having an account for the coupon issuer, the redemption merchant or the consumer may further enhance the functionality of the electronic coupon server system 101 and the corresponding method for managing electronic coupons.

The coupon issuer, the redemption merchant and the consumer access the electronic coupon server system 101 over a network 190 (e.g., the Internet) through client devices such as a personal computer 181, a compact electronic device 182 (e.g., a netbook, or a tablet), or a mobile electronic device 183 (e.g., a mobile phone or iPod touch). The preferred tool for the consumer to download and use the coupon is a mobile device such as a mobile phone, especially a smart phone.

The electronic coupon server system 101 is programmed and configured to perform the method for managing electronic coupons as illustrated herein.

In one embodiment, the electronic coupon server system 101 also has a downloadable coupon app 1015 which is a software application package and can be downloaded by the consumer to his or her mobile electronic device 183 for an improved couponing experience. The downloadable coupon app 1015, once downloaded and installed on the mobile electronic device 183, is executable to perform the method for applying an electronic coupon as described herein below. It is noted, however, a standalone downloadable coupon app 1015 is optional, and the consumer may download electronic coupons to the mobile electronic device 183 using preinstalled third-party software on the mobile electronic device 183. In addition, the downloadable coupon app 1015 may be stored on a different server such as an app store of a mobile phone manufacturer or a mobile service provider instead.

In one embodiment, a mobile web interface is used to access the server and user accounts. The consumer can browse and save coupons at the server side, and does not need download the application into the mobile electronic device. The mobile web interface can be used to redeem the coupons saved in user accounts.

In one embodiment, prior to the issuing an electronic coupon or facilitating the redemption of the electronic coupon on the electronic coupon server system, the involved parties have already registered a respective account with each party's information, and have accepted the use terms of the system. The parties are assumed to have access to competent equipment such as computers, mobile electronic devices, Internet connections and other communication means, and if necessary, have already downloaded and installed the appropriate software on the equipment.

In particular, the merchant (e.g., a retailer, a shop, a restaurant, etc.) has obtained one or more merchant identifiers to uniquely identify itself At the same time, regardless of whether a consumer has registered a consumer account at the electronic coupon server system 101, the coupon redemption process will involve some form of a characteristic of the consumer. The merchant identifier and the consumer characteristic will be described in further detail in a later section of this description.

Using the above-described account system and acquiring the information of merchant identifier and consumer characteristic help facilitate record-keeping of couponing process for the involved parties. Lack of such record-keeping is one of the primary reasons that discourage businesses from using a mobile coupon system. Accordingly, having such record-keeping capabilities may be important to improve coupon auditing, settlement and analysis and to encourage businesses to use a mobile coupon system.

In addition, the account system and the identifying information may further improve the cooperation relationship between the redemption merchant and the coupon issuer (e.g., a manufacturer or service provider) during coupon clearing if they are separate entities. Such cooperation relationship may play a significant role in the coupon redemption process because the lack of a trust mechanism between the coupon issuer and the redemption merchant has become a serious hurdle in applying coupons to promote sales.

In essence, the system and method disclosed herein improves the reliability of couponing process, while retaining the convenience of mobile electronic coupons.

The method may be illustrated from a server's point of view and a mobile electronic device's point of view, respectively.

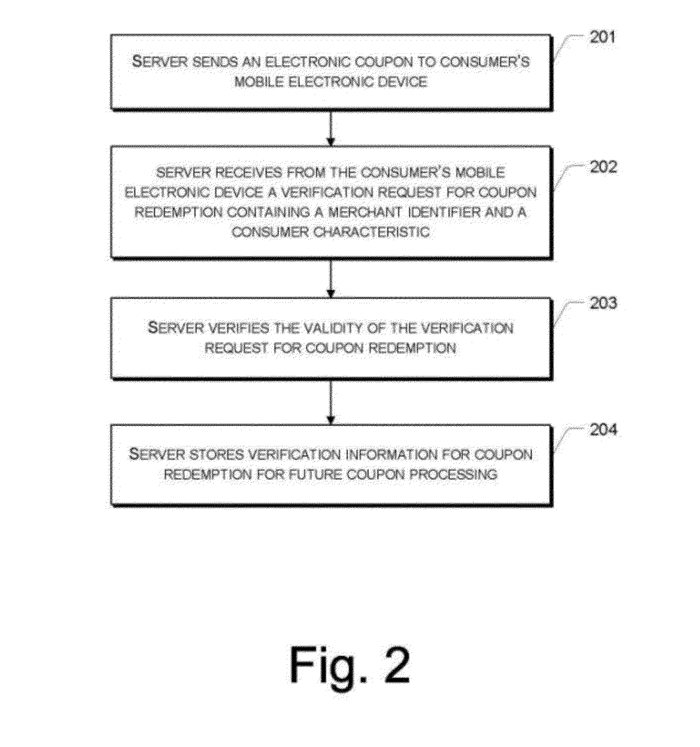

FIG. 2 shows an exemplary block flowchart of the method for managing electronic coupons in accordance with the present disclosure. The block flowchart in FIG. 2 is illustrated from a server's point of view.

At block 201, server sends an electronic coupon to a consumer's mobile electronic device. The server is part of the electronic coupon server system 101.

Coupons may either be accessed by the consumer as a result of a deliberate search, but may also be automatically sent to the consumer as a function of a user subscription. User subscription may be personalized to allow each consumer to receive future coupons of his or her particular interest. Coupons that match the subscription criteria can be automatically sent to the consumer's account, or to the consumer through e-mail or internal messages such as instant messaging.

Block 201 may be carried out upon a request by a consumer intending to use the electronic coupon to make a purchase of a product or service. This can be accomplished using any practical means. In one preferred embodiment, the consumer's mobile electronic device has a special-purpose application program (an app, such as an iPhone app) installed that can connect to the coupon server system and perform search and downloading functions. The consumer searches, identifies and downloads a coupon using the app. Alternatively, such functions may be performed using a web browser instead of a special-purpose application program. For example, the server can host a website which can be visited by the consumer; and the consumer browses or searches for a coupon of interest and request for a selected coupon to be sent to the mobile electronic device. Alternatively, the server may use a “pushing mode” to send the electronic coupon to the consumer's mobile electronic device without first receiving an explicit request by the consumer. This can be either a random mass promotion, or a targeted promotion based on previously acquired consumer preferences.

Any mobile electronic device that has wireless Internet connection to the coupon server system may be used for this purpose. In a preferred embodiment, a mobile phone is used. The mobile phone may use a variety of wireless communication technologies such as 3G, 4G, EDGE, GPRS or CDMA to complete this step. Other mobile electronic devices, such as iPod touch, wireless Internet-enabled tablets and PDA, may also have the required capabilities for wireless communication in accordance with the present disclosure.

Preferably, the consumer's mobile electronic device has a special-purpose application program installed that can connect to the coupon server system and perform search and downloading functions. However, such functions may be performed using a mobile web browser alone instead of a special-purpose application program. But a special-purpose application program (i.e., an iPhone app) is preferred for a superior user experience.

At block 202, the server receives from the consumer's mobile electronic device a verification request for redemption of the electronic coupon. The verification request for redemption contains a merchant identifier and a consumer characteristic. Block 202 occurs at a time of the consumer's attempting to make a purchase of the product using the previously received electronic coupon. At this block, the consumer shows the electronic coupon displayed on the mobile electronic device to the merchant, typically a cashier at the checkout of a retailer. Upon examining the electronic coupon, the merchant enters a merchant identifier into the mobile electronic device. There may be a variety of ways for entering the merchant identifier, as will be described in further detail in a subsequent section of the present disclosure.

In addition to a merchant identifier and a consumer characteristic, the verification request for redemption of the electronic coupon may also contain other information such as the product information and other details related to the purchase transaction.

Preferably, the merchant identifier allows the coupon server system to uniquely identify the merchant. Instead of assigning an arbitrary code or number, the server system may automatically calculate the merchant identifier using an algorithm to uniquely identify the merchant. The merchant identifier is assigned to the merchant when the merchant registers an account with the server.

An example of a merchant identifier is an alphanumerical string which can be manually entered by the merchant into the consumer's mobile electronic device. Another example of a merchant identifier is a graphic pattern such as a barcode that can be read into the consumer's mobile device by an image recognition technique instead of manually typed in. The image recognition of the graphic pattern may be performed through a video camera on the consumer's mobile electronic device and software installed on the mobile device. Typically, a barcode uniquely represents the merchant because the merchant identifier is encoded in the barcode. An operator at the merchant's place such as a cashier may ask the consumer to hand over the mobile electronic device to perform such a function. This saves the trouble of manually typing the merchant identifier, reduces the chance of error, and increase the coupon redemption efficiency.

In addition to the common 1D barcodes, more sophisticated graphic patterns, such as 2D barcodes (e.g., QR codes, Microsoft tags) and other digitally decodable images may be used.

The above graphic pattern-based merchant identifiers, including their creation and reading-out, are managed by the coupon server system 101. A special-purpose module may be embedded in the coupon server system 101 to serve this purpose. The coupon server system 101 may preferably provide indicators to guide the merchant on when and how to use such identifiers.

A merchant identifier should generally not be shared by more than one merchant in order to avoid confusion in identification. However, one merchant may have more than one merchant identifier. In certain circumstances, possessing multiple merchant identifiers by a single merchant may serve a function. For example, the merchant may assign different merchant identifiers with different attributes such as privileges, geographic areas, branches, etc. The merchant may also distribute different merchant identifiers to different operators accepting coupons on behalf of the merchant.

The merchant identifiers should be kept confidential to outsiders and unauthorized personnel. Especially, the merchant identifiers should not be spread among the general public and become known to consumers who may abuse them. In some cases, a merchant may ask the server to reassign a new merchant identifier to them.

In addition to allowing the consumer's mobile electronic device to read the merchant identifier using the image recognition technique in case that the merchant identifier is in a form of image, such as barcode, the merchant may be allowed to manually enter the merchant identifier at the consumer's mobile electronic device. Alternatively, the consumer's mobile electronic device may receive the merchant identifier through a short distance wireless communication method such as NFC or Bluetooth.

The consumer characteristic may be any information that is personally associated with the consumer. The level of identification of the consumer by the consumer characteristic does not have to be so specific as to uniquely identify the consumer as an individual. However, it should at least have sufficient amount of specificity to make it reasonably difficult for anyone to fake such characteristic information without an existing legitimate association with the consumer. Examples of a consumer characteristic include a hardware serial number of the consumer's mobile electronic device, a mobile phone number, a home phone number, and an e-mail address or other personal information of the consumer. The hardware serial number of the consumer's mobile electronic device is usually stored in a memory (e.g., a ROM) of the mobile electronic device and readable by a program.

In addition to information that is personally associated with the consumer, the consumer characteristic may also include location information which can be obtained by GPS or the IP address of the consumer's mobile device for determining the physical location of the customer at the time of making the purchase.

In particular, if the mobile electronic device is a mobile phone, the most convenient and reliable information that can serve to identify the consumer may be the mobile phone number or a hardware identification number (such as a serial number) that identifies the mobile phone. Either of these two may be a hurdle to discourage a merchant from entering a fake number and make a bogus claim for coupon clearing.

The consumer characteristic may be manually entered by the consumer. Alternatively, the consumer characteristic is automatically extracted from the consumer's mobile electronic device. For example, the hardware serial number of a mobile electronic device stored in an internal memory of the mobile electronic device may be automatically extracted.

The consumer characteristic information helps the coupon server system associate the coupon redemption with a real consumer who has actually made the purchase with the coupon. The mobile phone number or e-mail address of the consumer may also be used by the coupon issuer and the merchant to contact the consumer after the purchase in order to verify the coupon transaction. Such information also provides useful statistics to the coupon issuer and the merchant in addition to verifying the coupon transaction.

At block 203, the server verifies the verification request for redemption based on the information contained therein. The server may first verify the identity of the merchant by checking the merchant identifier received with the verification request for redemption of the electronic coupon. The server maintains a list of valid merchant identifiers and checks every merchant identifier against the list in order to validate the identity of the merchant. As the merchant identifier is assigned by the server using a certain algorithm rather than an arbitrary code or number, it is hard to be fabricated. If the received merchant identifier matches one of the valid merchant identifiers in the list, the server considers the merchant identity valid and associates the verification request for redemption with the merchant account corresponding to the merchant identifier. In case where the coupon issuer is not the same as the merchant, the server may also associate the verification request for redemption of the electronic coupon with the account of the coupon issuer which issued the coupon. If the received merchant identifier does not match any merchant identifier in the list, the server may reject the coupon verification request for redemption.

The verification request may also be determined by a variety of other factors. For example, the verification request for redemption may be considered invalid if the coupon itself is invalid even if a valid merchant identifier has been received. A particular coupon may have a maximum number of redemptions, and if the maximum number has been reached, the server may decide that the coupon has become invalid. Likewise, a coupon may become invalid due to exceeding of a certain time limitation, geographic limitation, merchant restriction (e.g., the coupon may be held inapplicable toward a certain merchant), consumer restriction (e.g., the same consumer may not be allowed to apply the same coupon for more than a certain number of times), etc.

If a coupon that has already been used is not allowed to be used again, or the number of times the coupon has been used has reached the maximum number prescribed by the coupon issuer, the current coupon is determined to be invalid. The coupon server system may also mark the coupon stored on the server side as being invalid and starts to restrict the future downloads. If the coupon is invalid with regard to all consumers, the coupon server system will not allow any future downloads by any consumer. If the coupon is invalid only with regard to the current consumer or the current mobile electronic device, the coupon server system will not allow any future download of the same coupon by the same consumer or the same mobile electronic device. Because the coupon server system keeps a record of not only the total number of downloads of the coupon, but also the number of downloads of the coupon by a particular consumer or by a certain mobile electronic device, it can effectively prevent repeated use of the same coupon by the same consumer.

If the coupon has a restriction on the maximum number of uses, either in general or with regard to each consumer, the coupon server system makes a deduction to the available number of uses of the coupon each time when the coupon has been verified for a valid redemption. When the available number of uses becomes zero, the coupon server system sends a denial notice to reply the verification request for coupon redemption. At the same time, the corresponding coupon will become unavailable for downloading.

Furthermore, if the merchant is registered at the coupon server system with its physical location information, it is also possible to determine the physical location of the consumer's mobile electronic device and to see if it matches the registered address of the merchant whose identifier is included in the verification request for redemption of the electronic coupon. If it does not, it may indicate fraudulent use of the coupon. The physical location of a mobile electronic device may be determined using a variety of ways such as GPS, cellular tower triangulation, and Wi-Fi IP address. In these examples, information such as mobile communication base station address and the IP address of the mobile electronic device at the time when the verification request for redemption is transmitted is used for determining the location of the mobile electronic device.

Upon verifying the verification request, the server sends a notice to indicate a verification result. In accordance with the present disclosure, it is preferred that the notice be sent to the same consumer's mobile electronic device from which the verification request for redemption of the electronic coupon was received to maintain the integrity of the couponing process. However, the notice may be sent directly to the merchant if the merchant is equipped with proper communication means to receive such a notice from the server.

Upon seeing the notice sent from the server indicating that the coupon is valid, the merchant completes the purchase and redeems the coupon.

At block 204, the server stores verification information, which may include the verification request and the verification result for future coupon processing. Such stored information may serve a critical purpose of record-keeping and substantiating a claim by the merchant during coupon clearance. For example, the verification request contains the coupon information and the merchant identifier which are useful for record-keeping of the involved parties. Also, because the verification request contains a consumer characteristic such as a mobile device identification number or a mobile phone number, such records help reduce the risk of bogus claims by the merchant for coupon clearance.

It is noted that the above process is not restricted to the particular order as illustrated. For example, block 204 may take place before block 203. The order of these two blocks is insignificant.

Optionally, upon the completion of the purchase, additional information indicating the completion of the purchase and the coupon redemption may be sent to the server. This can also be sent directly from the electronic mobile device. Alternatively, similar information may be sent from the merchant's equipment to the server. This additional information may be combined with the previous verification request for redemption of the electronic coupon to further reinforce the evidence for subsequent coupon clearing between the merchant and the manufacturer (coupon issuer). In a case where the redemption merchant and the coupon issuer are the same entity, transmitting and storing information of the verification request at the server may still serve a purpose of record-keeping and statistics.

In practice, the validity of the coupon may be first checked, and the merchant identifier is subsequently entered to form a verification request for redemption of the electronic coupon to be sent to the server. For example, the receiving of the verification request in block 202 may take place after the consumer's mobile electronic device has first received from the server a notice indicating the validity of the electronic coupon itself.

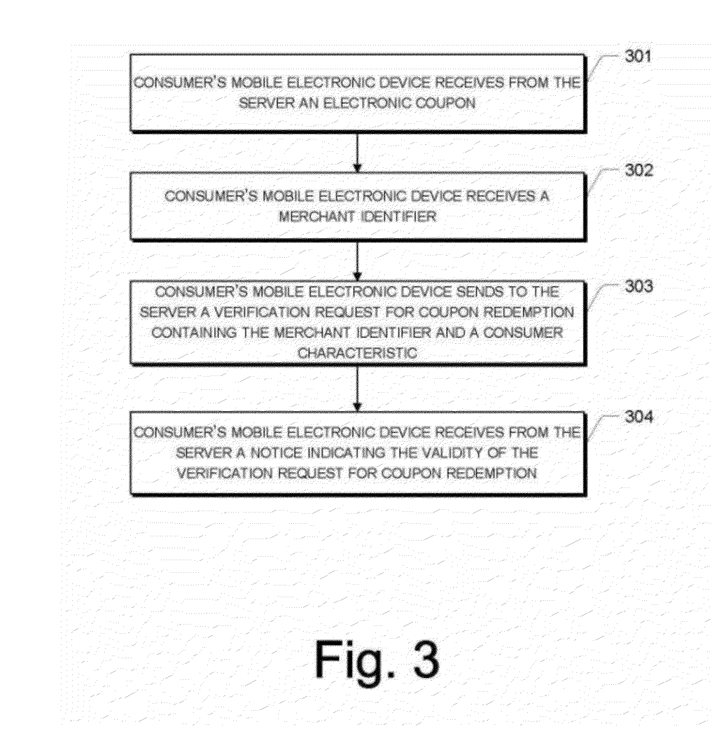

FIG. 3 shows another exemplary block flowchart of the method for managing electronic coupons in accordance with the present disclosure. The block flowchart in FIG. 3 is the same process shown in FIG. 2 but illustrated from a mobile electronic device's point of view.

At block 301, the consumer's mobile electronic device receives from the server an electronic coupon.

At block 302, the consumer's mobile electronic device receives a merchant identifier when making a purchase using the received electronic coupon.

At block 303, the consumer's mobile electronic device sends to the server a verification request for redemption of the electronic coupon. The verification request contains a merchant identifier and a consumer characteristic.

At block 304, the consumer's mobile electronic device receives from the server a notice indicating a verification result. If the coupon is indicated to be valid, the merchant completes the purchase and redeems the coupon.

The method may be further illustrated from a whole-system point of view as follows.

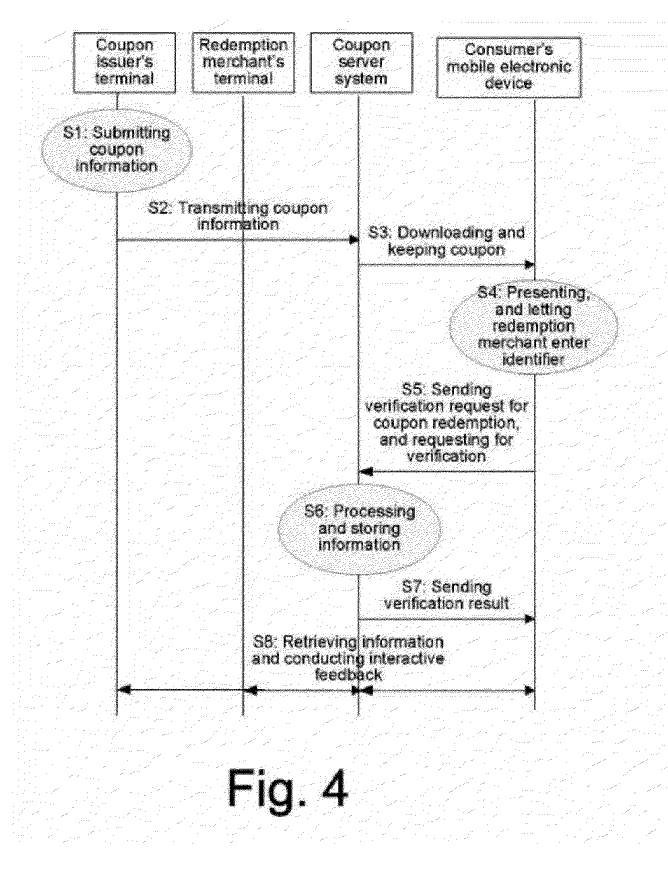

FIG. 4 shows an integrated flowchart illustrating the method for managing electronic coupons in accordance with the present invention. The integrated flowchart of FIG. 4 shows the timelines of each party involved in the redemption process of a coupon used in a purchase.

In some circumstances, the coupon issuer and the redemption merchant may be the same entity and would thus use the same terminal in FIG. 4. For example, a restaurant may be both the coupon issuer and the redemption merchant for its services promoted using coupons. When the coupon issuer and the redemption merchant are different entities, however, they may use separate terminals to interact with the coupon server system. In addition, although just one terminal for each party is illustrated in FIG. 4 for simplicity, each party may not be limited to just a single terminal to access the coupon server system.

The procedures taking place in the whole system are described as follows.

S1: At coupon issuer's terminal, the coupon issuer fills out the coupon information and submits the information through a user interface. The user interface may be a webpage interface provided by the coupon server system, or an application user interface provided by a program installed at the coupon issuer's terminal The coupon issuer's terminal may be a desktop computer, laptop computer, a compact computing device, or a mobile communication device such as a netbook or smart phone.

Coupon information entered and submitted by the coupon issuer includes the content of the coupon and its restrictions. The content of the coupon may include the subject of the coupon such as a product or a service, coupon value such as a discount rate or discount amount, UPC bar code identifying the coupon, etc. Exemplary coupon restrictions include an expiration date, whether the coupon can be used multiple times by the same consumer, and the maximum total amount of redemptions. Coupon information defines the conditions under which the coupon may be applied and redeemed, helping the coupon server system to manage the coupons, and enabling the coupon issuer to control and conduct a promotion campaign according to its original plan to effectively control the cost of promotion activities.

The coupon information may define other conditions according to the goals of the promotion campaign. For example, it may define a period of delay (e.g., 30 minutes.) for the coupon to become applicable after being downloaded by the consumer. This may help solve the problem that the consumer might download the coupon at the last minute of checking out. Consumers and retailers sometimes search for coupons for goods already placed in the shopping cart. This is a problematic practice because it contradicts to the promotional goal of the coupon issuer. Setting a period of delay may provide a solution to the above problem. If a substantial delay (e.g., half an hour) is used, both the merchant and the consumer are discouraged from looking for coupons at the last minute of checking out for the goods already placed in the shopping cart. In addition, having a period of delay is likely to prolong the consumer's stay at the merchant's place, which is the desired result for businesses.

The coupon issuer may log onto its account at the coupon server system to modify or even delete the content of the coupon any time after the coupon has been issued.

S2: The coupon issuer's terminal transmits the coupon information to the coupon server system. The transmission may be conducted over the Internet. The coupon issuer's terminal may access the Internet either through a cable connection or wirelessly.

S3: The consumer downloads the coupon from the coupon server system to the consumer's mobile electronic device. If the coupon issuer has set a limit to the number of download times of the coupon in the above step S1, the coupon server system will automatically stop downloading the coupon once the maximum number of downloads has been reached.

S4: The consumer presents the coupon to a merchant and lets the merchant enter a merchant identifier. The mobile electronic device displays the coupon, and in addition to showing the relevant content of the coupon, also displays a user interface that allows the merchant to enter its merchant identifier.

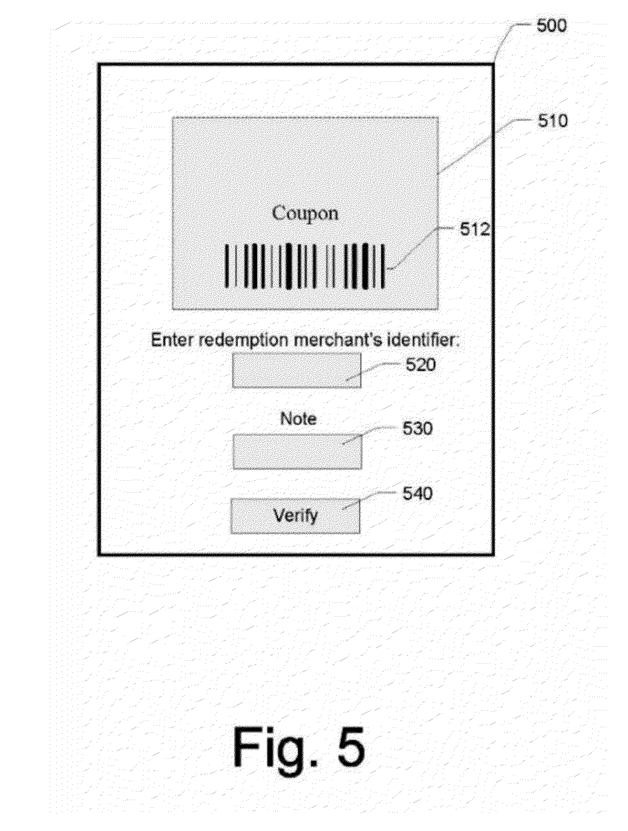

FIG. 5 shows an exemplary electronic coupon displayed on the consumer's mobile electronic device. The electronic coupon 510 is displayed on a screen 500 of the mobile electronic device. In addition to the general coupon content (not shown), the electronic coupon 510 may also have a barcode 512 that can be directly scanned by a scanner of the merchant to identify and record the coupon in the point-of-sale system of the merchant. An input area 520 is further displayed along with the coupon 510 for the merchant to manually enter the merchant identifier. An optional input area 530 is provided for the merchant or the consumer to enter supplemental information associated with the coupon and the purchase. A verification button 540 is provided to submit and verify the entered information.

Referring back to FIG. 4, the process of couponing process continues after S4.

S5: The consumer's mobile electronic device sends a verification request for redemption of the electronic coupon to the coupon server system. The verification request for redemption of the electronic coupon is created at the consumer's mobile electronic device using an installed program to include the merchant identifier and a characteristic of the consumer.

S6: Upon receiving the verification request for redemption of the electronic coupon, the coupon server system processes and stores verification information including the verification request and the verification result for future verification and coupon clearing purpose.

S7: The coupon server system sends a verification result to the consumer's mobile electronic device to be displayed to the consumer and the merchant.

In the embodiment illustrated herein, the verification request for redemption of the electronic coupon also contains a request to verify the validity of the coupon itself. The coupon server system checks the validity status of the coupon, and sends the verification result back to the consumer's mobile electronic device. However, requesting for a verification result of the coupon may be conducted as a separate operation, and may be performed either before S5 or after S5.

At the end of S7, upon receiving a positive verification result, the merchant redeems the coupon by taking an appropriate discount to the product or service that is being purchased by the consumer.

S8: After the coupon transaction has been completed, the coupon issuer, the merchant and the consumer may subsequently access the coupon server system to retrieve relevant information of their coupon redemption histories. If each party has an account, such information can be customized to contain highly relevant records. Parties involved in the same transaction may use the records of the coupon redemption history to conduct interactive business, such as information inquiries and coupon clearing.

After the coupon redemption, the parties, especially the consumer, may give a user review on the purchase experience through the mobile electronic device (or any other electronic device that has access to the coupon server system). Such user reviews may be stored, accumulated and displayed to other users for reference. Parties may log on to its own account to check the user review statistics, and may further give feedback or explanations to a particular transaction of interest. The feedback and review information may be open to all parties involved and may also be accessible by other parties such as other consumers. The coupon issuer and the merchant may log on to the coupon server system anytime to examine the accounts, check statistics, perform auditing work and conduct coupon clearing business. Due to the use of a unique procedure and use of a verification request for redemption that contains a merchant identifier and the consumer characteristic, the method for managing electronic coupons disclosed herein solves the long-standing problem of lacking substantiating evidence for electronic coupon redemption. The stored verification information including the verification request for redemptions and the verification result in accordance with the present disclosure facilitates coupon auditing, coupon settlement and coupon clearing procedures and reduces fraudulent coupon practices. After a successful clearing procedure, the coupon issuer (a manufacturer or service provider) reimburses the merchant for the proper amounts according to the coupon transaction records.

A server system may be adapted for managing electronic coupons in accordance with the present disclosure. The server system has at least one server which has a processor, a data storage, and communication means. The server is programmed to perform the coupon redemption procedure described herein. For example, the server sends an electronic coupon to a consumer's mobile electronic device, and receives from the consumer's mobile electronic device a verification request for redemption of the electronic coupon containing a merchant identifier and a consumer characteristic. The server further verifies the verification request for redemption according to the received information contained in the verification request for redemption, and stores the verification information for future coupon processing.

A downloadable software application package which can be stored on one or more computer readable media may also be created and used in accordance with the present disclosure. The software application package includes a plurality of instructions that, when installed on a mobile electronic device and executed by a processor through user interaction, causes the mobile electronic device to perform a coupon redemption procedure described herein. For example, the software application package causes the mobile electronic device to receive an electronic coupon from a server, receive a merchant identifier, send to a server a verification request for redemption of the electronic coupon containing the merchant identifier and a consumer characteristic, and receive from the server a notice indicating a verification result.

Preferably, however, the above coupon server system and the downloadable software application package are integrated into the same coupon managing system.

As illustrated above, because the verification request for redemption of the electronic coupon includes a merchant identifier which is determined by the coupon server system using a given algorithm, assigned to the merchant and registered at the coupon server system, it discourages the act of making up fake merchant identifiers. It also discourages the consumer from abusing the coupon system without actually making a purchase at a legitimate merchant accepting the coupon for redemption.

Because the verification request for redemption of the electronic coupon also includes a consumer characteristic, it further discourages the merchant from making up bogus coupon claims without a purchase by a consumer.

Another benefit of the disclosed system and method is that they offer an efficient solution for managing and controlling the use of coupons by setting conditions such as a maximum number of redemptions, repetitive usage of the coupon by the same consumer, and statistics of coupon usage.

While maintaining the convenience of mobile electronic coupons, the disclosed system and method are harder to be abused by fraudulent practices than existing electronic coupon systems. The end result is a combination of both the benefits of the electronic coupons and printed coupons. The system and method may be advantageously implemented to shorten the time cycle from issuing the coupon to redemption to more effectively promote sales of a product, and at the same time effectively prevent fraudulent acts in the process of coupon redemption and clearing.

It is appreciated that the potential benefits and advantages discussed herein are not to be construed as a limitation or restriction to the scope of the appended claims.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method for applying an electronic coupon, the method comprising:
sending an electronic coupon from a server to a consumer's mobile electronic device upon a request by the consumer;
receiving by the server from the consumer's mobile electronic device a verification request for redemption of the electronic coupon, the verification request containing a merchant identifier and a characteristic of the consumer;
verifying the verification request and sending a verification result to the mobile electronic device to allow redemption of the coupon by the merchant; and
storing at the server the verification request for future coupon processing.

2. The method as recited in claim 1, wherein the merchant identifier allows the coupon server system to uniquely identify the merchant.

3. The method as recited in claim 1, wherein the merchant identifier is automatically calculated and assigned by the server using an algorithm to uniquely identify the merchant.

4. The method as recited in claim 1, wherein the merchant identifier is a code which can be manually entered by the merchant into the consumer's mobile electronic device.

5. The method as identified in claim 1, wherein the merchant identifier comprises a pattern readable by the mobile electronic device using image recognition technique.

6. The method as recited in claim 1, wherein the mobile electronic device is a mobile phone, and the consumer characteristic comprises a mobile phone number associated with the mobile phone or a hardware identification number of the mobile phone.

7. The method as recited in claim 1, wherein the consumer characteristic comprises one or more of a hardware identification number of the mobile electronic device, an e-mail address of the consumer, a phone number, GPS location and IP address of the mobile electronic device.

8. The method as recited in claim 1, further comprising:
receiving at the server from the mobile electronic device a consumer feedback concerning the electronic coupon;
storing the consumer feedback at the server; and
allowing others to access to the consumer feedback.

9. The method as recited in claim 1, further comprising:
establishing at the server a user account system comprising an account for a coupon issuer and an account for the merchant, wherein the coupon issuer and the merchant may or may not be the same entity.

10. The method as recited in claim 1, wherein the server communicates to the mobile electronic device through any of 3G, 4G, EDGE, GPRS, CDMA and Wi-Fi wireless communication methods.

11. The method as recited in claim 1, wherein verifying the verification request comprises checking the merchant identifier against a list of merchant identifiers stored in the server.

12. The method as recited in claim 1, wherein verifying the verification request comprises:
determining a physical location of the mobile electronic device based on information contained in the verification request; and
checking the physical location of the mobile electronic device against an address of the merchant identified by the merchant identifier.

13. A method for applying an electronic coupon, the method comprising:
receiving an electronic coupon from a server at a consumer's mobile electronic device;
receiving at the consumer's mobile electronic device a merchant identifier;
sending to the server from the consumer's mobile electronic device a verification request for redemption of the electronic coupon, the verification request containing the merchant identifier and a consumer characteristic; and
receiving from the server a notice indicating a verification result.

14. The method as recited in claim 13, further comprising:
allowing the merchant to manually enter the merchant identifier at the consumer's mobile electronic device.

15. The method as recited in claim 13, further comprising:
allowing the consumer's mobile electronic device to automatically read the merchant identifier using an image recognition technique or an electrical transmission method.

16. The method as recited in claim 13, wherein receiving at the consumer's mobile electronic device the merchant identifier is conducted through a short distance wireless communication method.

17. The method as recited in claim 13, wherein the mobile electronic device is a mobile phone, and the consumer characteristic comprises a mobile phone number associated with the mobile phone or a hardware identification number of the mobile phone.

18. The method as recited in claim 13, wherein the consumer characteristic comprises one or more of a hardware identification number of the mobile electronic device, an e-mail address of the consumer, a phone number, GPS location and IP address of the mobile electronic device.

19. A server system adapted for managing electronic coupons, the server system comprising at least one server computer which has a processor, a data storage, and communication means, the server system being programmed to perform the following acts:
sending an electronic coupon to a consumer's mobile electronic device;
receiving from the consumer's mobile electronic device a verification request for redemption of the electronic coupon, the verification request containing a merchant identifier and a consumer characteristic;
verifying the verification request for redemption; and
storing the verification request for future coupon processing.

20. A downloadable software application package stored on one or more computer readable media, the software application package including a plurality of instructions that, when installed on a mobile electronic device and executed by a processor through user interaction, causes the mobile electronic device to:
receiving an electronic coupon from a server;
receiving a merchant identifier;
sending to the server a verification request for redemption of the electronic coupon, the verification request containing the merchant identifier and a consumer characteristic; and
receiving from the server a notice indicating a verification result.

21. A system adapted for managing electronic coupons, the system comprising:
a coupon server system including at least one server computer which has a processor, a data storage, and communication means; and
a software application package downloadable to a mobile electronic device communicating to the coupon server system through a wireless network,
wherein the coupon server system is programmed to send an electronic coupon to the consumer's mobile electronic device, receive from the consumer's mobile electronic device a verification request for redemption of the electronic coupon containing a merchant identifier and a consumer characteristic, verify the verification request, and store the verification request for future coupon processing, and
wherein the downloadable software application package including a plurality of instructions that, when executed by the mobile electronic device through user interaction, causes the mobile electronic device to receive the electronic coupon from the coupon server system, receive the merchant identifier from a merchant, send to the coupon server system the verification request for redemption of the electronic coupon, and receive from the coupon server system a notice indicating a verification result.
